(19) United States
(12) Patent Application Publication
(10) Pub. No.: US 2003/0223763 A1
(43) Pub. Date: Dec. 4, 2003

(54) Optical transmitter and optical communication system

(75) Inventor: Masato Tanaka, Yokohama-shi (JP)

Correspondence Address: McDERMOTT, WILL & EMERY, 600 13th Street, N.W., Washington, DC, 20005-3096, US

(73) Assignee: SUMITONO ELECTRIC INDUSTRIES, LTD.

(21) Appl. No.: 10/420,778

(22) Filed: Apr. 23, 2003

(30) Foreign Application Priority Data
May 28, 2002 (JP) 2002-154144

(51) Int. Cl. H04B 10/04

(52) U.S. Cl. 398/186; 398/182

(57) ABSTRACT

Provided are an optical transmitter and an optical communication system which are improved in terms of both light transmission quality and reception sensitivity. A laser diode 12 is driven by driver 11 by a direct intensity modulation method and emits laser light. An intensity modulator 13, to which intensity-modulated light is input from the laser diode 12 and from which the intensity-modulated light is output, has an input/output characteristic such that the greater the power Pᵢₙ of input light, the greater the ratio R (=Pₒᵤₜ/Pᵢₙ) between the power Pᵢₙ of light input to the intensity modulator 13 and the power Pₒᵤₜ of the light output from the intensity modulator 13.

### BACKGROUND OF THE INVENTION

1. Field of the Invention

The present invention relates to an optical transmitter that includes a light source driven by a direct intensity modulation method for emitting light, and an optical communication system that includes the optical transmitter.

2. Description of the Background Art

In an optical communication system, signal light output from an optical transmitter propagates through an optical fiber transmission line and is received at an optical receiver. The optical transmitter includes a light source, e.g. a laser diode, and outputs pulsed light as signal light by means of an external intensity modulation method or direct intensity modulation method. In the external intensity modulation method, continuous oscillation light is emitted from a laser diode, and this oscillation light is modulated by the external modulator and is output. On the other hand, in the direct intensity modulation method, the driving current that has been intensity-modulated is supplied to the laser diode and the oscillation light intensity-modulated according to the driving current is output from the laser diode. The direct intensity modulation method is advantageous in view of simple composition and low cost as compared with the external intensity modulation method.

FIGS. 9A and 9B are diagrams for explaining the direct intensity modulation method. FIG. 9A shows the time variation of the driving current supplied to the laser diode and FIG. 9B shows the time variation of the output power of the laser diode. The value of the driving current supplied to the laser diode is set to be greater than or smaller than a given bias value. According to this, the output power of the laser diode becomes power value “a” or power value “(a+b)”; however, an overshoot occurs at the onset of power. The extinction ratio of this output light is represented by 10log₁₀ (b/a) and can be adjusted by the bias value of the driving current.

FIGS. 10A to 10C are diagrams for explanation in the case where the extinction ratio is large in the direct intensity modulation method. FIG. 10A shows the time variation of the output power of the laser diode, FIG. 10B shows the frequency fluctuation of light emitted by the laser diode and FIG. 10C shows the time variation of the power of the light which has reached an optical receiver. When the extinction ratio is high as shown in FIG. 10A, the oscillation frequency changes considerably greatly as shown in FIG. 10B. The change of the oscillation frequency at the onset of the pulsed light is called “chirp”. If a chirp occurs, the waveform of the light which has reached an optical receiver is greatly distorted and the quality of the light transmission degrades due to the optical fiber transmission line having chromatic dispersion as shown in FIG. 10C.

FIGS. 11A and 11B are diagrams for explaining the case in which the extinction ratio is small in the direct intensity modulation method. FIG. 11A shows the time variation of output power of the laser diode, and FIG. 11B shows the frequency fluctuation of light emitted from the laser diode. If the extinction ratio is small as shown in FIG. 11A, the change of the oscillation frequency is small as shown in FIG. 11B at the onset of the output pulse, and hence the degree of the deterioration of signal waveform due to the chromatic dispersion of an optical fiber transmission line is small. However, when the extinction ratio is small, the reception sensitivity at the optical receiver is poor.

Thus, if the extinction ratio is high, the light transmission quality degrades due to the chromatic dispersion of the optical fiber transmission line, and conversely when the extinction ratio is low, the reception sensitivity is inferior. That is, the improvement of light transmission quality and that of the reception sensitivity have a trade-off relationship.

### SUMMARY OF THE INVENTION

The object of the present invention is to provide an optical transmitter in which both light transmission quality and reception sensitivity are improved, and an optical communication system that is equipped with such optical transmitter.

In order to achieve this object, the present invention provides an optical transmitter which comprises (1) a light source driven by the direct intensity modulation method and (2) an intensity modulator having an input/output characteristic such that the ratio R (R=Pₒᵤₜ/Pᵢₙ, where Pᵢₙ is the power of input light, and Pₒᵤₜ is the power of output light) increases according to the increase of the power Pᵢₙ of input light, and in which light input from the light source is output via the intensity modulator.

Also, the present invention provides an optical communication system which comprises such optical transmitter and in which signal light output from the optical transmitter propagates through an optical fiber transmission line.

The intensity modulator may be such that the amount of light absorption decreases as the power Pᵢₙ of input light increases, and when the power Pᵢₙ of input light is less than the threshold value, all input light is absorbed. When the power Pᵢₙ of input light exceeds the threshold, the amount of the input light corresponding to the threshold value may be absorbed. For example, the intensity modulator may preferably include a saturable absorber.

The intensity modulator may output input light after optical amplification thereof, and therefore it may be such that the gain of optical amplification may be increased according to the increase of the power Pᵢₙ of input light, and when the power Pᵢₙ of input light is less than the threshold value, it may optically amplify input light and output it. For example, the intensity modulator may comprise: (1) an optical coupler including a first port, second port, third port and fourth port such that light input to the first port is divided so as to be output to the second port and third port, and light input to the second port is output to the first port and fourth port, and light input to the third port is output to the first port and fourth port; (2) an optical amplifier which is provided in the optical path between the second port and third port and used for optically amplifying and outputting input light, and (3) an optical fiber which is provided on either of the optical path between the optical amplifier and the second port of the optical coupler and the optical path between the optical amplifier and the third port of the optical coupler.

In such case, the ratio (n_{NL}/A_{eff}) of nonlinear refractive index n_{NL} of the optical fiber to the effective core area A_{eff} may be equal to or more than 1×10⁻⁹W⁻¹ in the wavelength of light emitted from the laser diode.

It is desirable that the maximum chirp at the onset of the pulsed light emitted from the laser diode that is pulse-driven be equal to or less than 10 GHz. Preferably, the extinction ratio of the pulsed light is equal to or less than 8 and equal to or more than 4.

### BRIEF DESCRIPTION OF THE DRAWINGS

FIG. 1A shows the composition of an optical transmitter 10 according to one embodiment of the present invention. FIGS. 1B and 1C are graphs showing an example of the characteristics of the input/output of the intensity modulator 13 that is a component part of the optical transmitter 10.

FIGS. 2A and 2B are graphs showing the second example of the input/output characteristics of the intensity modulator 13.

FIGS. 3A and 3B are graphs showing the third example of the input/output characteristics of the intensity modulator 13.

FIGS. 4A and 4B are graphs showing the fourth example of the input/output characteristics of the intensity modulator 13.

FIG. 5 is a graph showing the fifth example of the input/output characteristic of the intensity modulator 13.

FIG. 6 is a graph showing the sixth example of the input/output characteristic of the intensity modulator 13.

FIG. 7A is a schematic diagram illustrating an exemplary structure of the intensity modulator 13. FIG. 7B shows the input/output characteristic of the intensity modulator 13.

FIG. 8 is a schematic diagram showing an example of an optical communication system 1 according to the present invention.

FIGS. 9A and 9B are graphs showing the relationship between a driving current and output light in the direct intensity modulation method.

FIGS. 10A to 10C are diagrams for explaining examples where the extinction ratio is large in the direct intensity modulation method.

FIGS. 11A and 11B are diagrams for explaining examples where the extinction ratio is small in the direct intensity modulation method.

### DETAILED DESCRIPTION OF THE INVENTION

Embodiments of the present invention are explained below by referring to the accompanying drawings. In the drawings, the same number refers to the same part to avoid duplicate explanation. The ratios of the dimensions in the drawings do not necessarily coincide with the explanation.

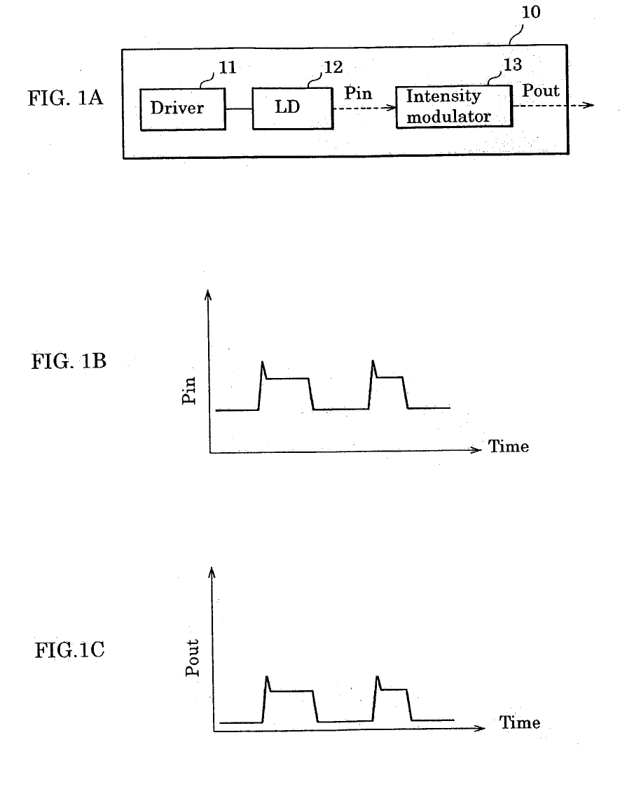

First, an embodiment of the optical transmitter according to the present invention is explained. FIGS. 1A to 1C are diagrams for explaining the optical transmitter 10 according to one embodiment of the present invention. FIG. 1A shows the composition of the optical transmitter 10, and FIG. 1B shows the time variation of the power Pᵢₙ of light emitted from a laser diode 12 and input to the intensity modulator 13. FIG. 1C shows the time variation of the power Pₒᵤₜ of light output from the intensity modulator 13.

As shown in FIG. 1A, the optical transmitter 10 is equipped with a driver 11, the laser diode 12 as a light source, and the intensity modulator 13. The driver 11 outputs an intensity-modulated driving current and supplies the driving current to the laser diode 12. The laser diode 12 driven by the driving current supplied from the driver 11 emits intensity-modulated laser light. That is, the laser diode 12 is driven by the direct intensity modulation method and emits laser light. The DFB laser or the Fabry-Perot type laser diode can be used as the laser diode.

The intensity modulator 13, to which intensity-modulated light having a power Pᵢₙ emitted from the laser diode 12 is input and from which the intensity-modulated light having a power Pₒᵤₜ is output, has an input/output characteristic such that the greater the power Pᵢₙ of input light, the greater the ratio R is. The intensity modulator 13 outputs, according to such input/output characteristic, the light that has been emitted from the laser diode 12.

That is, in the optical transmitter 10, light emitted from the laser diode 12 driven by the driver 11 by the direct intensity modulation method is output in the state in which the extinction ratio is increased according to the input/output characteristic of the intensity modulator 13. Furthermore, even if the extinction ratio of light emitted from the laser diode 12 is small, the extinction ratio of light output from the intensity modulator 13 increases. Also, since the extinction ratio of light emitted from the laser diode 12 may be small, the degree of chirp decreases. Therefore, in an optical communication system which transmits signal light output from the optical transmitter 10, the deterioration of light transmission quality due to the chromatic dispersion of an optical fiber transmission line is restrained, and the deterioration of the reception sensitivity is also restrained. Thus, this optical communication system can improve both the light transmission quality and the reception sensitivity.

It is desirable that the maximum chirp at the onset of pulsed light output from the laser diode 12 be 10 GHz or less. In such case, the waveform distortion of light due to chirp can be reduced sufficiently. Preferably, the extinction ratio of light emitted from the pulse-driven laser diode 12 is equal to or less than 8. In such case, the waveform distortion due to chirp can be reduced sufficiently. Also, it is desirable that the extinction ratio of the pulsed light emitted from the pulse-driven laser diode 12 be equal to or more than 4. In such case, the waveform distortion at a lower level due to nonlinear optical phenomenon can be restrained.

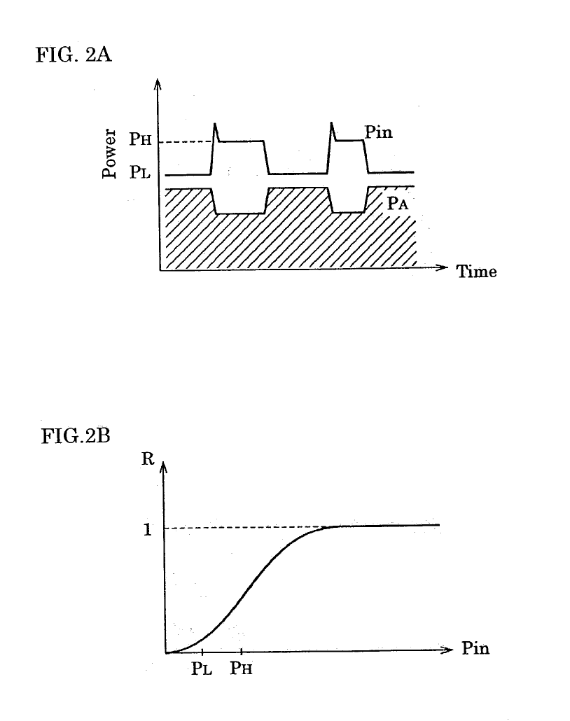

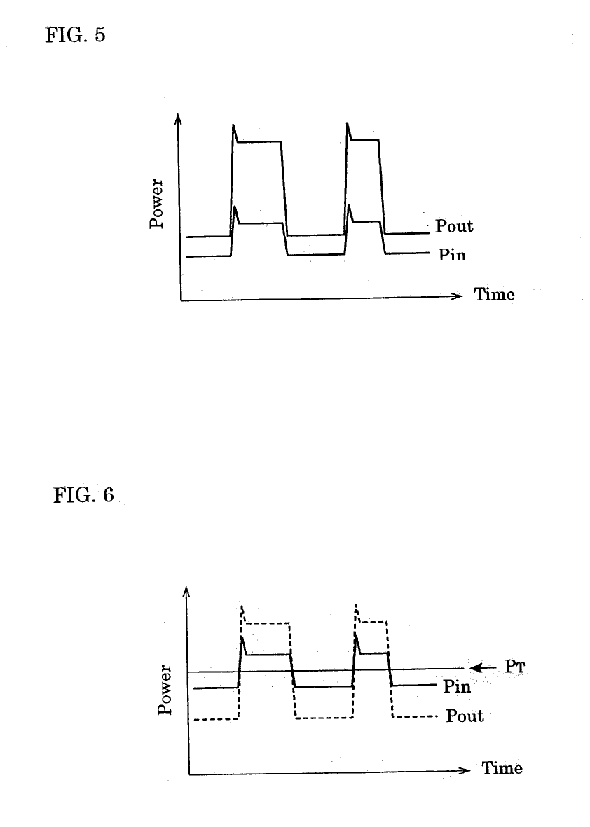

Next, the input/output characteristics of the intensity modulator 13 contained in the optical transmitter 10 according to the present embodiment will be further explained. FIGS. 2A to 6 are diagrams for explaining the input/output characteristics of the intensity modulator 13. FIGS. 2A to 4B show the input/output characteristics of the intensity modulator 13 in the case where the intensity modulator 13 has no optical amplification feature. FIGS. 2A, 3A, and 4A show the time variation of the power Pᵢₙ of input light, and the time variation of the absorption power P_{A}=Pᵢₙ−Pₒᵤₜ, respectively. FIGS. 2B, 3B, and 4B show the input/output characteristics (Pᵢₙ vs. R, or Pᵢₙ vs. Pₒᵤₜ). The input/output characteristics of the intensity modulator 13 shown in each of FIGS. 5 and 6 are those in the case where the intensity modulator 13 has the function to optically amplify input light, and each figure shows the time variation of the power Pᵢₙ of input light and that of the power Pₒᵤₜ of output light.

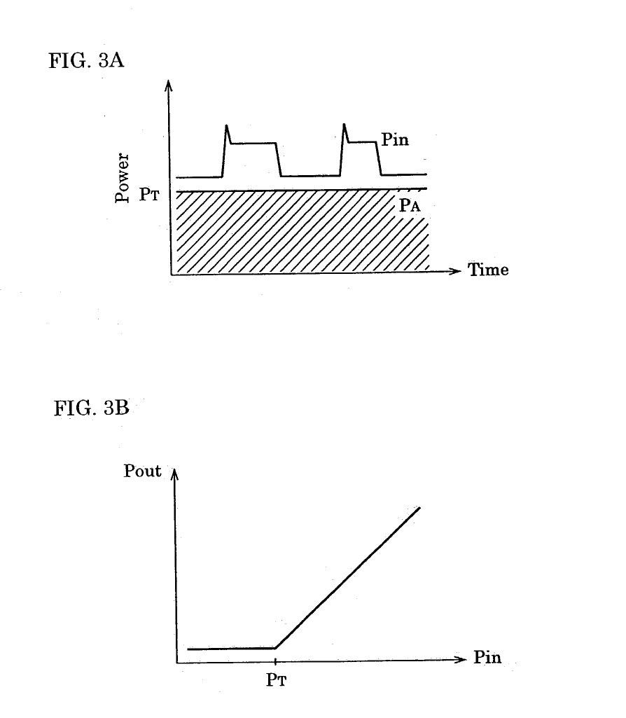

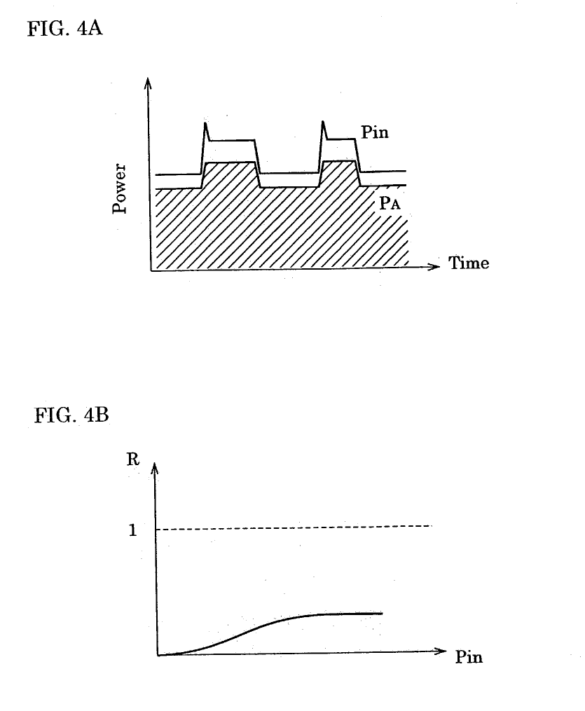

The input/output characteristics of the intensity modulator 13 as shown in FIGS. 2A and 2B are such that the greater the power Pᵢₙ of input light, the smaller the absorption power P_{A} (the hatching parts) is, and the greater the ratio R is. The input/output characteristics of the intensity modulator 13 as shown in FIGS. 3A and 3B are such that when the power Pᵢₙ of input light is equal to or less than the threshold value PT, all of the input light is absorbed, and when the power Pᵢₙ of input light exceeds the threshold value, the input light is absorbed to the extent corresponding to the threshold value. That is, only when the power Pᵢₙ of input light is greater than the threshold value, the power Pₒᵤₜ of output light which is the difference between the input light power and the threshold value is obtained. The input/output characteristics of the intensity modulator 13 as shown in FIGS. 4A and 4B are such that the greater the power Pᵢₙ of input light, the greater the absorption power P_{A} (the hatching parts) is, whereas the ratio R is great. Among the input/output characteristics shown in FIGS. 2A to 4B, that shown in FIG. 2A exhibits the greatest improvement effect of the extinction ratio, and that shown in FIG. 3A exhibits the second greatest improvement.

The input/output characteristic of the intensity modulator 13 as shown in FIG. 5 is such that the greater the power Pᵢₙ of input light, the greater the gain of optical amplification is. The input/output characteristic of the intensity modulator 13 as shown in FIG. 6 is such that when the power Pᵢₙ of input light is equal to or less than the threshold value P_{T}, a part of the input light is absorbed, and when the power Pᵢₙ of input light exceeds the threshold value, input light is output after it has been optically amplified. In the cases of the input/output characteristics as shown in FIGS. 5 and 6, the intensity modulator 13 has an optical amplification feature, and enables the long-haul transmission. Moreover, in the case of the input/output characteristic shown in FIG. 6, a part of input light is absorbed when the power Pᵢₙ of input light is equal to or less than the threshold value, therefore the excessive optical amplification is restrained and the noise factor improves.

The composition of the intensity modulator 13 contained in the optical transmitter 10 according to the present embodiment will be further explained. In the case of the intensity modulator 13 having no optical amplification feature, the composition preferably includes a saturable absorber. The saturable absorber consists of a substance such as Cr⁴⁺:YAG crystal, for example, which absorbs input light when the input light power is small, and the absorption percentage decreases when the input light power is greater. When a saturable absorber is used in the intensity modulator 13, it is possible to achieve downsizing by integrating the laser diode 12 and the intensity modulator 13.

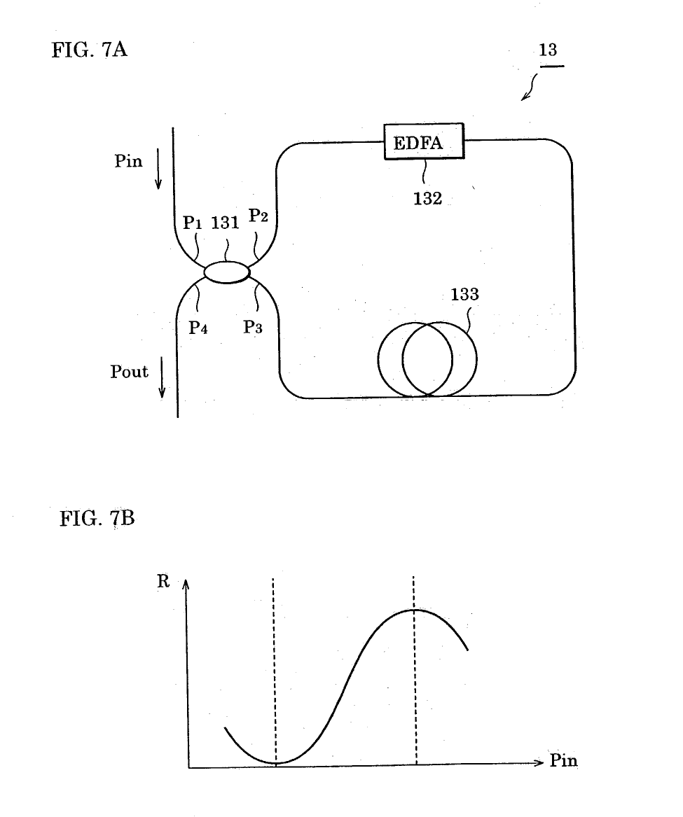

Also, the composition shown in FIGS. 7A and 7B may preferably be used for the intensity modulator 13 having an optical amplification feature. FIGS. 7A and 7B schematically show an example of the intensity modulator 13. FIG. 7A shows the composition of the intensity modulator 13 and FIG. 7B shows its input/output characteristic. The intensity modulator 13 shown in FIG. 7A includes an optical coupler 131, optical amplifier 132 and optical fiber 133. The optical coupler 131 has a first port P₁, second port P₂, third port P₃ and fourth port P₄. This optical coupler 131 branches light input to the first port P₁ for outputting into the second port P₂ and third port P₃. It branches light input to the second port P₂ so as to output into the first port P₁ and fourth port P₄. It also branches light input to the third port P₃ into the first port P₁ and fourth port P₄.

The optical amplifier 132 and optical fiber 133 are provided on the optical path between the second port P₂ and third port P₃. The optical amplifier 132 optically amplifies and outputs input light. Erbium-Doped Fiber Amplifier is preferably used for this. It is desirable that the optical fiber 133 have high nonlinearity and that the ratio (n_{NL}/A_{eff}) of nonlinear refractive index n_{NL} to effective core area A_{eff} be equal to or more than 1×10⁻⁹W⁻¹ in the wavelength of light emitted from the laser diode 12.

In this intensity modulator 13, light emitted from the laser diode 12 is input to the first port P₁, and branched by the optical coupler 131 so as to be output from the second port P₂ and third port P₃. The light output from the second port P₂ propagates through the optical fiber 133 after it has been amplified optically by the optical amplifier 132, and enters the third port P₃. On the other hand, the light output from the third port P₃ is amplified optically by the optical amplifier 132 after it has propagated through the optical fiber 133 and enters the second port P₂. Apart of light that has entered the second port P₂ and third port P₃ is output from the fourth port P₄ as output light from the intensity modulator 13.

As compared with light propagating counterclockwise through the optical fiber 133 before passing through the optical amplifier 132, light propagating clockwise to enter the optical fiber 133 after passing through the second optical amplifier 132 has greater power. Consequently, it tends to suffer from self phase modulation in the optical fiber 133 having high nonlinearity, thereby causing different phase variation. Therefore, the ratio R (=Pₒᵤₜ/Pᵢₙ) between the power Pₒᵤₜ of light output from the fourth port P₄ and the power Pᵢₙ of input light fluctuates repeatedly as shown in FIG. 7B with respect to the increase of the power Pᵢₙ of light that is emitted from the laser diode 12 and enters the first port P₁. In the range from the power Pᵢₙ of input light where the ratio R is minimal to the power Pᵢₙ of input light where the ratio R becomes maximal in FIG. 7B, the greater the power Pᵢₙ of input light, the greater the gain of optical amplification is, and hence the greater the ratio R becomes.

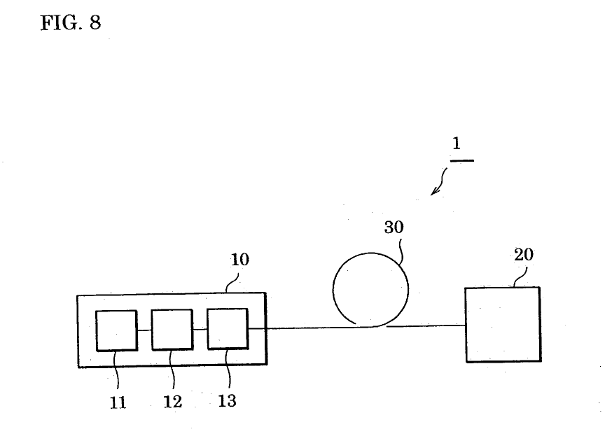

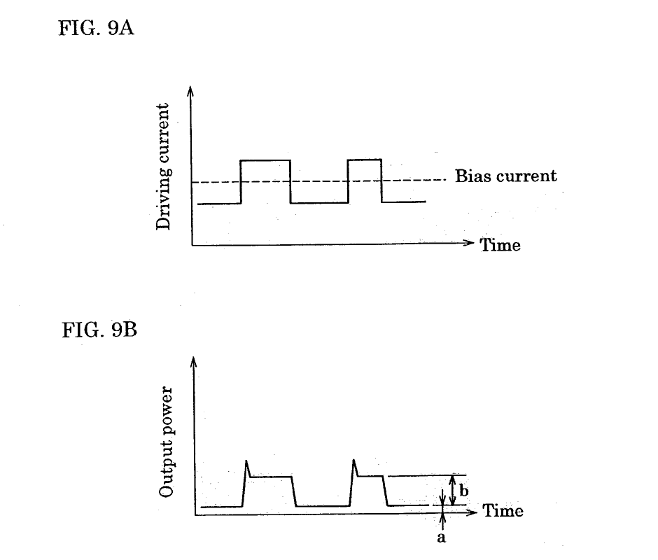

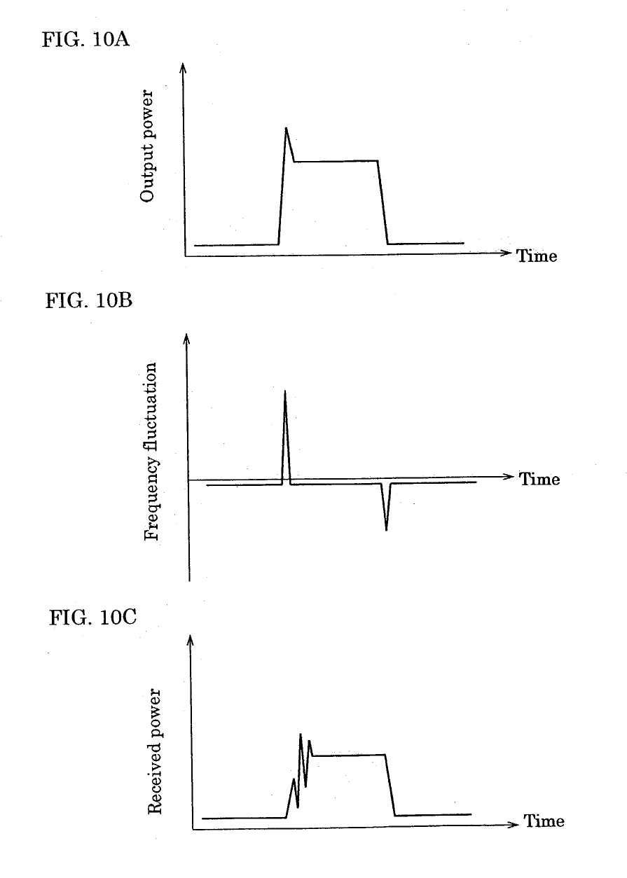

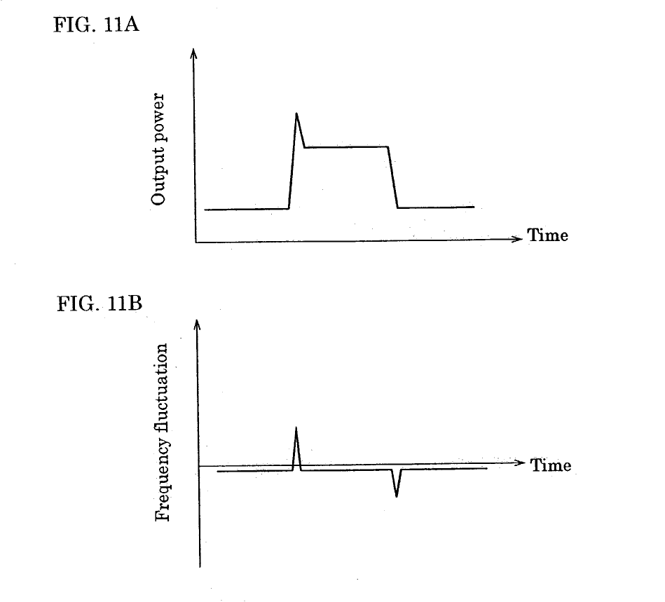

An embodiment of the optical communication system according to the present invention will be described. FIG. 8 is a schematic diagram showing the structure of an optical communication system 1 according to the present embodiment. The optical communication system 1 shown in FIG. 8 is equipped with an optical transmitter 10, an optical receiver 20 and an optical fiber transmission line 30. The optical transmitter 10 is the above-described embodiment of the present invention and has the driver 11, laser diode 12, and intensity modulator 13. The optical fiber transmission line 30 is provided between the optical transmitter 10 and the optical receiver 20, and transmits signal light emitted from the optical transmitter 10 to the optical receiver 20. The optical receiver 20 receives signal light which has propagated through the optical fiber transmission line 30.

In the optical communication system 1, light emitted from the laser diode 12 driven by the driver 11 by the direct intensity modulation method is modulated based on the input/output characteristics of the intensity modulator 13 so that the extinction ratio increases, and is discharged therefrom as signal light into the optical fiber transmission line 30. The signal light propagates through the optical fiber transmission line 30 and is received by the optical receiver 20. In this optical communication system 1, despite a small extinction ratio of light emitted from the laser diode 12, the extinction ratio of signal light output from the intensity modulator 13 increases. Also, since a small extinction ratio of light emitted from the laser diode 12 may be acceptable, the degree of the chirp of signal light decreases. Therefore, in the optical communication system 1 which transmits signal light discharged from this optical transmitter 10, the deterioration of the light transmission quality due to the chromatic dispersion of the optical fiber transmission line 30 can be restrained, as well as the degradation of the reception sensitivity at the optical receiver 20. This optical communication system 1 is improved in terms of both light transmission quality and reception sensitivity.

The entire disclosure of Japanese Patent Application No. 2002-154144 filed on May 28, 2002 including the specification, claims drawings and summary are incorporated herein by reference in its entirety.

What is claimed is:

1. An optical transmitter comprising a light source and an intensity modulator, said light source being driven by a direct intensity modulation method, and said intensity modulator having an input/output characteristic such that the greater the ratio R, the greater the power Pᵢₙ of input light, where R is the ratio (Pₒᵤₜ/Pᵢₙ) between the power Pᵢₙ of input light and the power Pₒᵤₜ of output light, wherein light emitted from said light source is output via said intensity modulator.

2. An optical transmitter according to claim 1, wherein said light source is a laser diode.

3. An optical transmitter according to claim 1, wherein said intensity modulator is such that the greater the power Pᵢₙ of input light, the smaller the quantity of light absorption.

4. An optical transmitter according to claim 1, wherein said intensity modulator absorbs all of light input thereinto when the power Pᵢₙ of input light is less than a threshold value, and said intensity modulator absorbs input light corresponding to the threshold value when the power Pᵢₙ of input light exceeds the threshold value.

5. An optical transmitter according to claim 1, wherein said intensity modulator optically amplifies and outputs input light such that the greater the power Pᵢₙ of the input light, the greater the gain of optical amplification.

6. An optical transmitter according to claim 1, wherein said intensity modulator can optically amplify and output input light such that when the power Pᵢₙ of the input light is equal to or less than a threshold value, said intensity modulator absorbs the input light, and when the power Pᵢₙ of the input light exceeds the threshold value said intensity modulator optically amplifies and outputs the input light.

7. An optical transmitter according to claim 1, wherein said intensity modulator includes a saturable absorber.

8. An optical transmitter according to claim 1, wherein said intensity modulator comprises an optical coupler, an optical amplifier, and an optical fiber;
said optical coupler including a first port, second port, third port, and fourth port for branching input light such that light input to the first port is output to the second port and the third port; light input to the second port is output to the first port and the fourth port; and light input to the third port is output to the first port and the fourth port;
said optical amplifier being provided on an optical path between the second port and third port of said optical coupler, and optically amplifying and outputting input light;
said optical fiber being provided either on an optical path between the second port of said optical coupler and said optical amplifier, and on an optical path between the third port of said optical coupler and the optical amplifier.

9. An optical transmitter according to claim 8, wherein the ratio (n_{NL}/A_{eff}) at the wavelength of light emitted from said light source is equal to or more than 1×10⁻⁹ W⁻¹, where n_{NL} is the nonlinear refractive index of said optical fiber and A_{eff} is the effective core area of said optical fiber.

10. An optical transmitter according to claim 1, wherein the maximum chirp at the onset of pulsed light output from said light is equal to or less than 10 GHz.

11. An optical transmitter according to claim 1, wherein the extinction ratio of pulsed light emitted from said light source is equal to or less than 8.

12. An optical transmitter according to claim 11, wherein the extinction ratio of pulsed light emitted from said light source is in a range from 4 to 8.

13. An optical communication system which includes an optical transmitter according to claim 1 and which allows signal light output from said optical transmitter to propagate through an optical fiber transmission line.
